(19) United States
(12) Patent Application Publication
(10) Pub. No.: US 2018/0367263 A1
(43) Pub. Date: Dec. 20, 2018

(54) Downlink Control Signaling to Enable Preemption and CBG-Based (Re)Transmission

(71) Applicant: Sharp Laboratories of America, Inc., Camas, WA (US)

(72) Inventors: Kai Ying, Vancouver, WA (US); Tatsushi Aiba, Vancouver, WA (US); John M. Kowalski, Vancouver, WA (US)

(21) Appl. No.: 16/008,426

(22) Filed: Jun. 14, 2018

Related U.S. Application Data
(63) Continuation of application No. PCT/US2018/037421, filed on Jun. 13, 2018.
(60) Provisional application No. 62/520,286, filed on Jun. 15, 2017.

(51) Int. Cl. H04L 1/18; H04W 72/12

(52) U.S. Cl. CPC H04L 1/1887; H04W 72/14; H04L 1/1812; H04W 72/1273

(57) ABSTRACT

A method includes configuring, by a base station, at least one of: a first timing indicator indicating a first delay between a downlink (DL) grant for a codeblock group (CBG)-based transmission and the CBG-based transmission; a second timing indicator indicating a second delay between the CBG-based transmission and a hybrid automatic repeat request acknowledgement (HARQ-ACK) for the CBG-based transmission; and a third timing indicator indicating a third delay between the CBG-based transmission and another DL grant for a pre-Acknowledgement/Non-Acknowledgement (pre-A/N) retransmission of the CBG. The method also includes transmitting, by the base station, a scheduling downlink control information (DCI) over a physical downlink control channel (PDCCH), the scheduling DCI comprising at least one of the first, second, and third timing indicators.

### CROSS-REFERENCE TO RELATED APPLICATION(S)

The present application claims the benefit of and priority to a provisional U.S. Patent Application Ser. No. 62/520,286 filed on Jun. 15, 2017, entitled “Pardon the Interruption: Downlink Control Signaling to Enable Preemption and CBG-based (Re)Transmission,” Attorney Docket No. SLA3750P (hereinafter referred to as “SLA3750P application”). The disclosure of the SLA3750P application is hereby incorporated fully by reference into the present application.

### FIELD

The present disclosure relates generally to communication systems. More specifically, the present disclosure relates to downlink control signaling to enable preemption and codeblock group (CBG)-based (re)transmission.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

Implementations of the present technology will now be described, by way of example only, with reference to the attached figures.

FIG. 1 is a block diagram illustrating one implementation of one or more next generation NodeBs (gNBs) and one or more user equipments (UEs) in which systems and methods for UCI operations may be implemented, in accordance with implementations of the present application.

FIG. 2 is an example of a resource grid for a downlink, in accordance with an implementation of the present application.

FIG. 3 is an example of a resource grid for an uplink), in accordance with an implementation of the present application.

FIGS. 4A, 4B, 4C, and 4D show examples of several numerologies, in accordance with implementations of the present application.

FIGS. 5A, 5B, 5C, and 5D show examples of subframe structures, in accordance with implementations of the present application.

FIGS. 6A, 6B, 6C, 6D, 6E, and 6F show examples of slots and sub-slots, in accordance with implementations of the present application.

FIGS. 7A, 7B, 7C, and 7D show examples of scheduling timelines, in accordance with implementations of the present application.

FIGS. 8A and 8B show examples of downlink control channel monitoring regions), in accordance with implementations of the present application.

FIGS. 9A and 9B show examples of downlink control channel each having more than one control channel elements), in accordance with implementations of the present application.

FIGS. 10A, 10B, and 10C show examples of uplink control channel structures), in accordance with implementations of the present application.

FIG. 11 is a block diagram illustrating one implementation of a gNB, in accordance with an implementation of the present application.

FIG. 12 is a block diagram illustrating one implementation of a UE, in accordance with an implementation of the present application.

FIG. 13 is a diagram illustrating signal flow and timing for CBG-based HARQ (re)transmission, in accordance with an implementation of the present application.

FIG. 14 is a diagram illustrating signal flow and timing for CBG-based HARQ (re)transmission with a preemption indication (PI), in accordance with an implementation of the present application.

FIG. 15A is a flowchart illustrating a method by a base station, in accordance with an implementation of the present application.

FIG. 15B is a flowchart illustrating a method by a UE, in accordance with an implementation of the present application.

### DETAILED DESCRIPTION

A base station is described. The base station includes a non-transitory machine-readable medium storing computer-executable instructions; a processor configured coupled to the non-transitory computer-readable medium, and configured to execute the computer-executable instructions to: configure at least one of a first timing indicator indicating a first delay between a downlink (DL) grant for a codeblock group (CBG)-based transmission and the CBG-based transmission; a second timing indicator indicating a second delay between the CBG-based transmission and a hybrid automatic repeat request acknowledgement (HARQ-ACK) for the CBG-based transmission; and a third timing indicator indicating a third delay between the CBG-based transmission and another DL grant for a pre-Acknowledgement/Non-Acknowledgement (pre-A/N) retransmission of the CBG. The processor is configured to execute the computer-executable instructions to transmit a scheduling downlink control information (DCI) over a physical downlink control channel (PDCCH), the scheduling DCI comprising at least one of the first, second, and third timing indicators.

A method for providing downlink control signaling, by a base station, to enable preemption and CBG-based (re)transmission is described. The method includes configuring, by the base station, at least one of a first timing indicator indicating a first delay between a downlink (DL) grant for a codeblock group (CBG)-based transmission and the CBG-based transmission; a second timing indicator indicating a second delay between the CBG-based transmission and a hybrid automatic repeat request acknowledgement (HARQ-ACK) for the CBG-based transmission; and a third timing indicator indicating a third delay between the CBG-based transmission and another DL grant for a pre-Acknowledgement/Non-Acknowledgement (pre-A/N) retransmission of the CBG. The method also includes transmitting, by the base station, a scheduling downlink control information (DCI) over a physical downlink control channel (PDCCH), the scheduling DCI comprising at least one of the first, second, and third timing indicators.

A user equipment (UE) is described. The UE includes a non-transitory machine-readable medium storing computer-executable instructions; a processor configured coupled to the non-transitory computer-readable medium, and configured to execute the computer-executable instructions to: receive a scheduling downlink control information (DCI) over a physical downlink control channel (PDCCH), the scheduling DCI comprising at least one of: a first timing indicator indicating a first delay between a downlink (DL) grant for a codeblock group (CBG)-based transmission and the CBG-based transmission; a second timing indicator indicating a second delay between the CBG-based transmission and a hybrid automatic repeat request acknowledgement (HARQ-ACK) for the CBG-based transmission; and a third timing indicator indicating a third delay between the CBG-based transmission and another DL grant for a pre-Acknowledgement/Non-Acknowledgement (pre-A/N) retransmission of the CBG. The processor is configured to execute the computer-executable instructions to receive a CBG over a physical downlink shared channel (PDSCH) after the first delay from the DL grant; and transmit the HARQ-ACK after the second delay from the CBG-based transmission.

A method for downlink control signaling to enable preemption and CBG-based (re)transmission is described. The method includes receiving, by the user equipment (UE), a scheduling downlink control information (DCI) over a physical downlink control channel (PDCCH), the scheduling DCI comprising at least one of a first timing indicator indicating a first delay between a downlink (DL) grant for a codeblock group (CBG)-based transmission and the CBG-based transmission; a second timing indicator indicating a second delay between the CBG-based transmission and a hybrid automatic repeat request acknowledgement (HARQ-ACK) for the CBG-based transmission; and a third timing indicator indicating a third delay between the CBG-based transmission and another DL grant for a pre-Acknowledgement/Non-Acknowledgement (pre-A/N) retransmission of the CBG. The method also includes receiving, by the UE, a CBG over a physical downlink shared channel (PDSCH) after the first delay from the DL grant; and transmitting, by the UE, the HARQ-ACK after the second delay from the CBG-based transmission.

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary implementations described herein. However, it will be understood by those of ordinary skill in the art that the exemplary implementations described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary implementations described herein.

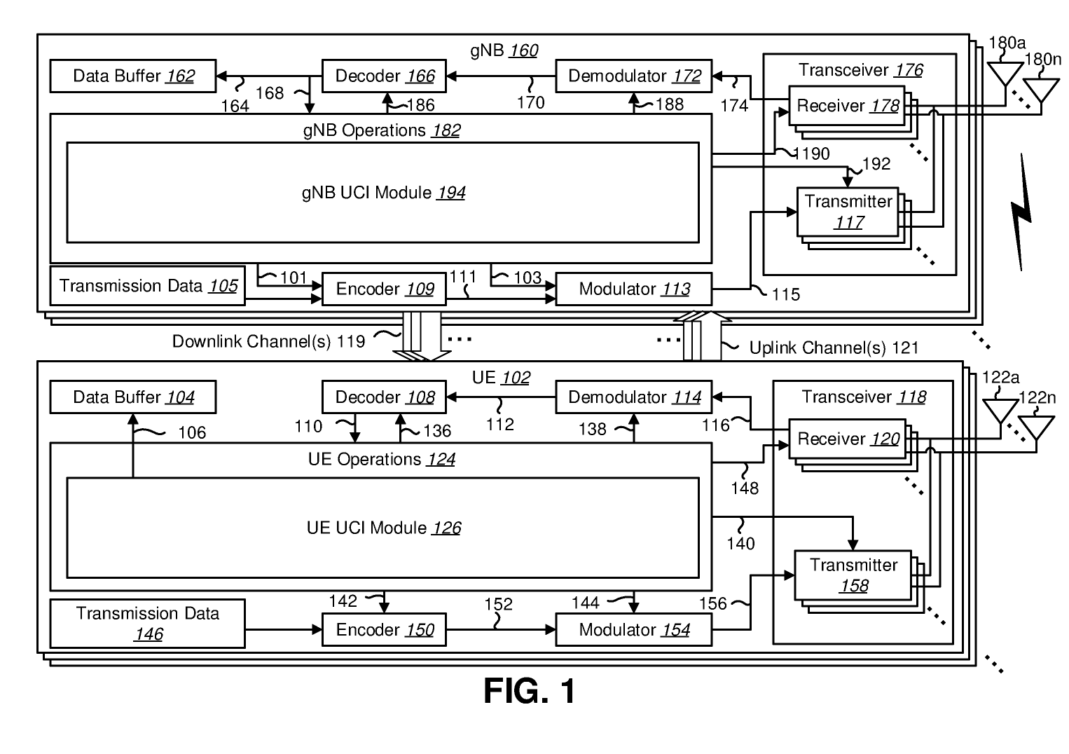

FIG. 1 is a block diagram illustrating one implementation of one or more next generation NodeBs (gNBs) 160 and one or more user equipments (UEs) 102 in which systems and methods for UCI operations may be implemented. The one or more UEs 102 communicate with one or more gNBs 160 using one or more antennas 122a-n. For example, a UE 102 transmits electromagnetic signals to the gNB 160 and receives electromagnetic signals from the gNB 160 using the one or more antennas 122a-n. The gNB 160 communicates with the UE 102 using one or more antennas 180a-n.

The UE 102 and the gNB 160 may use one or more channels 119, 121 to communicate with each other. For example, a UE 102 may transmit information or data to the gNB 160 using one or more uplink channels 121. Examples of uplink channels 121 include a PUCCH and a PUSCH, etc. The one or more gNBs 160 may also transmit information or data to the one or more UEs 102 using one or more downlink channels 119, for instance. Examples of downlink channels 119 include a physical downlink control channel (PDCCH), a physical downlink shared channel (PDSCH), etc. Other kinds of channels may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the gNB 160 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE decoded signal 110 may provide data that may be used by the UE operations module 124 to perform one or more operations.

In general, the UE operations module 124 may enable the UE 102 to communicate with the one or more gNBs 160. The UE operations module 124 may include one or more of a UE UCI module 126.

The UE UCI module 126 may perform UCI operations. UCI operations may include UCI generation, UCI multiplexing, UCI dropping, UCI compression, etc.

Each of the one or more gNBs 160 may include one or more transceivers 176, one or more demodulators 172, one or more decoders 166, one or more encoders 109, one or more modulators 113, a data buffer 162 and a gNB operations module 182. For example, one or more reception and/or transmission paths may be implemented in the gNB 160. For convenience, only a single transceiver 176, decoder 166, demodulator 172, encoder 109 and modulator 113 are illustrated in the gNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The gNB 160 may use the decoder 166 to decode signals. The decoder 166 may produce decoded signals 168 and a gNB-decoded signal 164 (also referred to as a first gNB-decoded signal 164). For example, the first gNB-decoded signal 164 may comprise received payload data, which may be stored in a data buffer 162. Another signal included in the decoded signals 168 (also referred to as a second gNB-decoded signal 168) may comprise overhead data and/or control data. For example, the second gNB decoded signal 168 may provide data that may be used by the gNB operations module 182 to perform one or more operations.

The gNB operations module 182 may enable the gNB 160 to communicate with the one or more UEs 102. The gNB operations module 182 may include one or more of a gNB UCI module 194.

The gNB UCI module 194 may perform UCI operations. UCI operations may include UCI extraction, UCI de-multiplexing, UCI reconstruction, UCI recompression, etc.

In the downlink, the OFDM access scheme with cyclic prefix (CP) may be employed, which may be also referred to as CP-OFDM. In the downlink, PDCCH, EPDCCH, PDSCH and the like may be transmitted. A downlink radio frame may comprise multiple pairs of downlink resource blocks (RBs) which is also referred to as physical resource blocks (PRBs). The downlink RB pair is a unit for assigning downlink radio resources, defined by a predetermined bandwidth (RB bandwidth) and a time slot. The downlink RB pair consists of two downlink RBs that are continuous in the time domain.

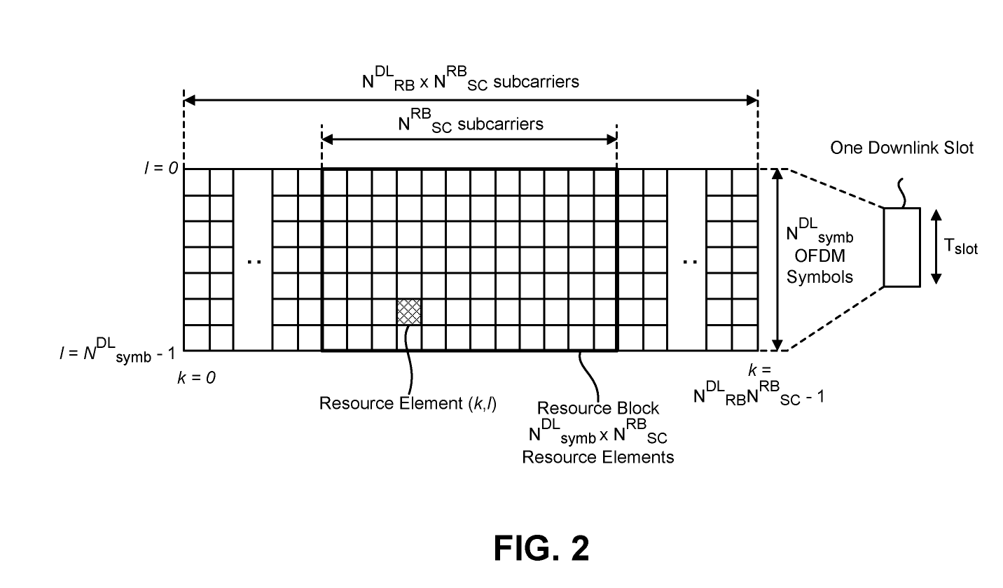

The downlink RB consists of twelve sub-carriers in frequency domain and seven (for normal CP) or six (for extended CP) OFDM symbols in time domain. A region defined by one sub-carrier in frequency domain and one OFDM symbol in time domain is referred to as a resource element (RE) and is uniquely identified by the index pair (k,l) in a slot, where k and 1 are indices in the frequency and time domains, respectively. While downlink subframes in one component carrier (CC) are discussed herein, downlink subframes are defined for each CC and downlink subframes are substantially in synchronization with each other among CCs. An example of a resource grid in a downlink is discussed in connection with FIG. 2.

In the uplink, in addition to CP-OFDM, a Single-Carrier Frequency Division Multiple Access (SC-FDMA) access scheme may be employed, which is also referred to as Discrete Fourier Transform-Spreading OFDM (DFT-S-OFDM). In the uplink, PUCCH, PDSCH, PRACH and the like may be transmitted. An uplink radio frame may comprise multiple pairs of uplink resource blocks. The uplink RB pair is a unit for assigning uplink radio resources, defined by a predetermined bandwidth (RB bandwidth) and a time slot. The uplink RB pair consists of two uplink RBs that are continuous in the time domain.

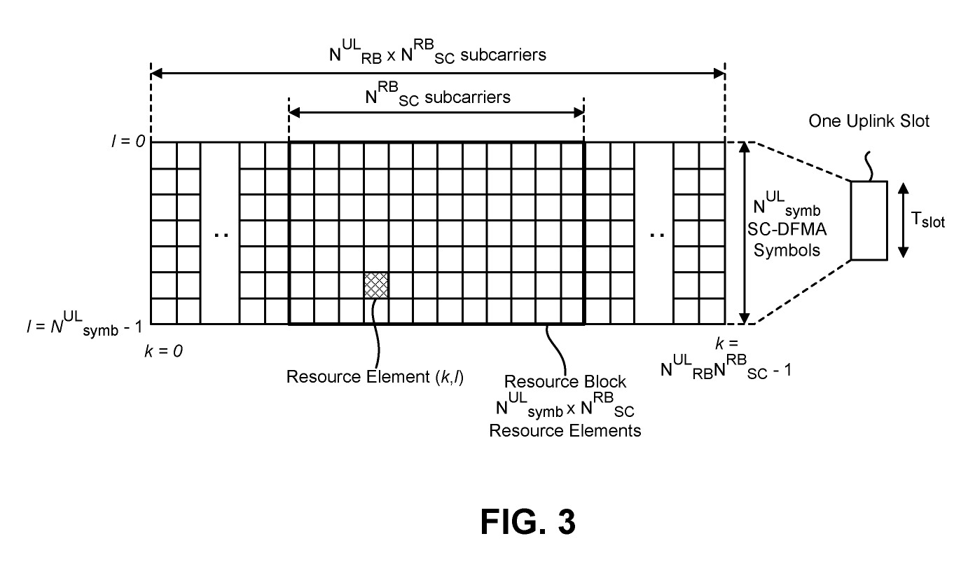

The uplink RB may comprise twelve sub-carriers in frequency domain and seven (for normal CP) or six (for extended CP) OFDM/DFT-S-OFDM symbols in time domain. A region defined by one sub-carrier in the frequency domain and one OFDM/DFT-S-OFDM symbol in the time domain is referred to as a resource element (RE) and is uniquely identified by the index pair (k,l) in a slot, where k and l are indices in the frequency and time domains respectively. While uplink subframes in one component carrier (CC) are discussed herein, uplink subframes are defined for each CC. An example of a resource grid in an uplink is discussed in connection with FIG. 3.

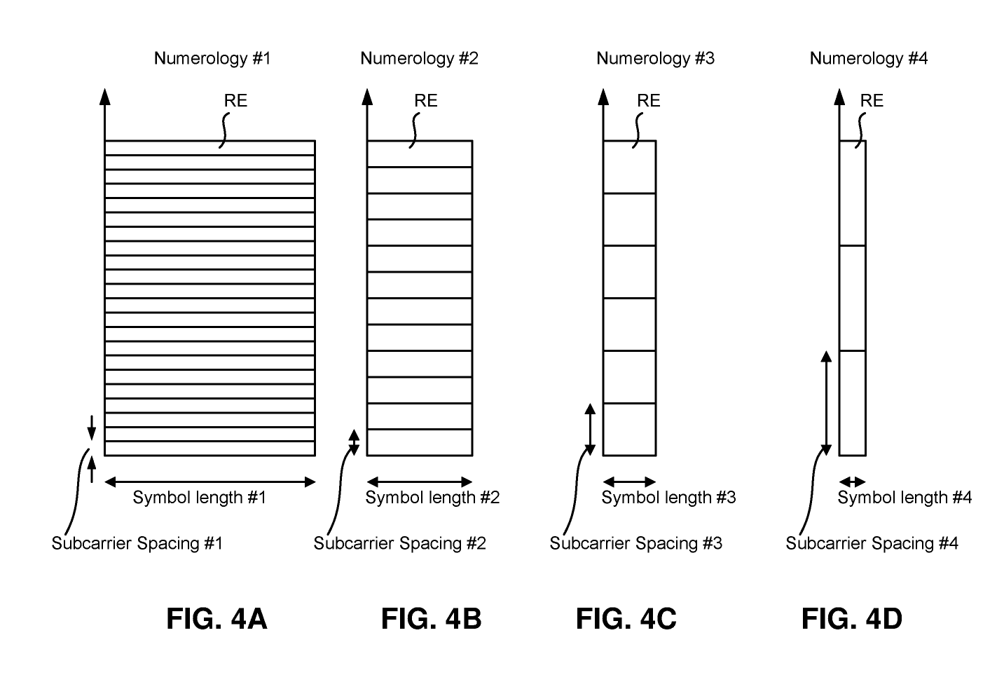

FIGS. 4A, 4B, 4C, and 4D show examples of several numerologies. The numerology #1 may be a basic numerology. For example, a RE of the basic numerology is defined with subcarrier spacing of 15 kHz in frequency domain and 2048 Ts+CP length (e.g., 160 Ts or 144 Ts) in time domain, where Ts denotes a baseband sampling time unit defined as 1/(15000*2048) seconds. For the i-th numerology, the subcarrier spacing may be equal to 15*2ⁱ and the effective OFDM symbol length 2048*2⁻ⁱ*Ts. It may cause the symbol length is 2048*2⁻ⁱ*Ts+CP length (e.g., 160*2⁻ⁱ*Ts or 144*2⁻ⁱ*Ts). In other words, the subcarrier spacing of the i+1-th numerology is a double of the one for the i-th numerology, and the symbol length of the i+1-th numerology is a half of the one for the i-th numerology. FIGS. 4A, 4B, 4C, and 4D show four numerologies, but the system may support another number of numerologies. Furthermore, the system does not have to support all of the 0-th to the I-th numerologies, i=0, 1, . . . , I.

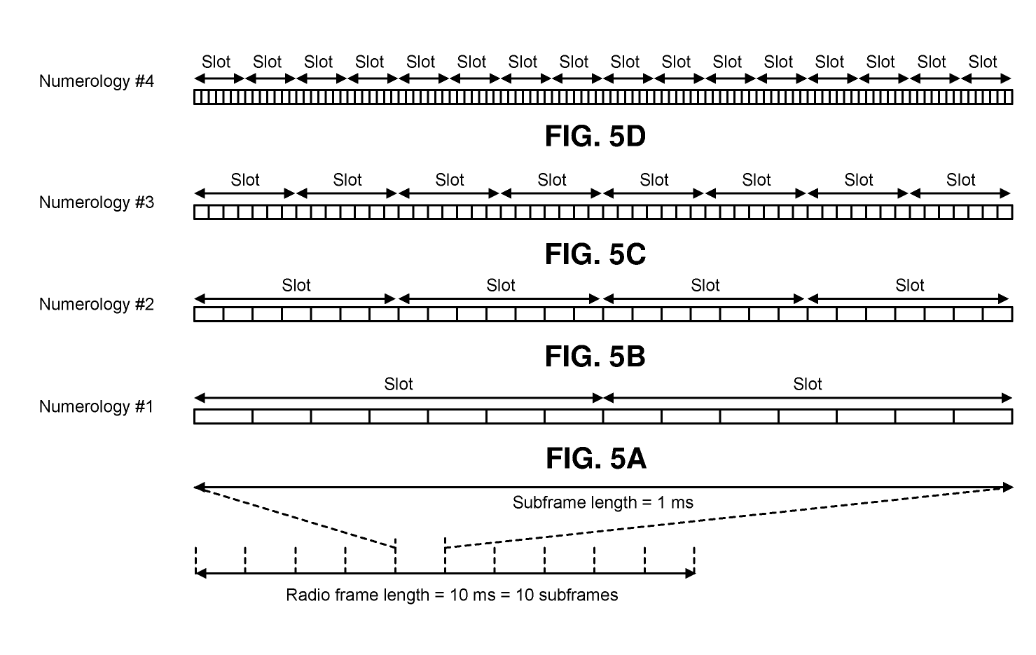

FIGS. 5A, 5B, 5C, and 5D show examples of subframe structures for the numerologies that are shown in FIGS. 4A, 4B, 4C, and 4D, respectively. Given that a slot consists of N^{DL}_{symb} (or N^{UJ}_{symb})=7 symbols, the slot length of the i+1-th numerology is a half of the one for the i-th numerology, and eventually the number of slots in a subframe (e.g., 1 ms) becomes double. It may be noted that a radio frame may consists of 10 subframes, and the radio frame length may be equal to 10 ms.

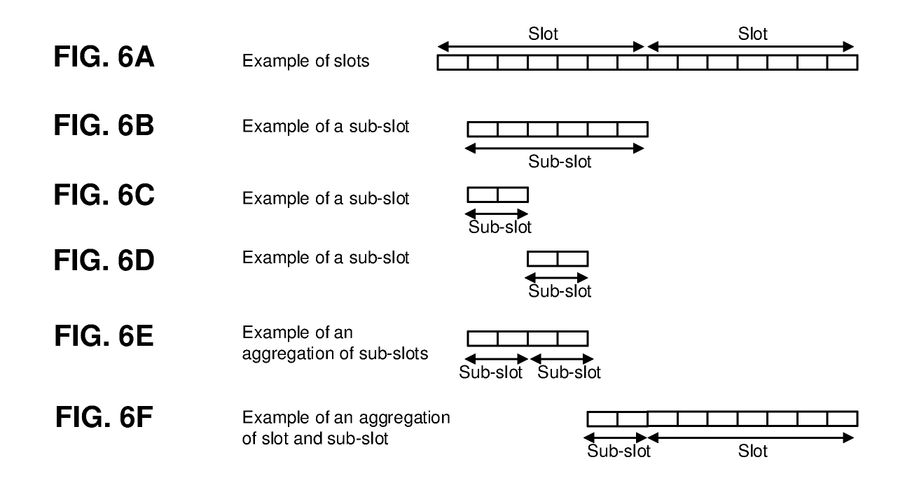

FIGS. 6A, 6B, 6C, 6D, 6E and 6F show examples of slots and sub-slots. If sub-slot is not configured by higher layer signaling, the UE and the gNB may only use a slot as a scheduling unit. More specifically, a given transport block may be allocated to a slot. If the sub-slot is configured by higher layer signaling, the UE and the gNB may use the sub-slot as well as the slot. The sub-slot may comprise one or more OFDM symbols. The maximum number of OFDM symbols that constitute the sub-slot may be N^{DL}_{symb}-1 (or N^{UL}_{symb}-1). The sub-slot length may be configured by higher layer signaling. Alternatively, the sub-slot length may be indicated by a physical layer control channel (e.g., by DCI format). The sub-slot may start at any symbol within a slot unless it collides with a control channel. There could be restrictions of mini-slot length based on restrictions on the starting position. For example, the sub-slot with the length of N^{DL}_{symb}-1 (or N^{UL}_{symb}-1) may start at the second symbol in a slot. The starting position of a sub-slot may be indicated by a physical layer control channel (e.g., by DCI format). Alternatively, the starting position of a sub-slot may be derived from information (e.g., search space index, blind decoding candidate index, frequency and/or time resource indices, PRB index, a control channel element index, control channel element aggregation level, an antenna port index, etc.) of the physical layer control channel which schedules the data in the concerned sub-slot. In cases when the sub-slot is configured, a given transport block may be allocated to either a slot, a sub-slot, aggregated sub-slots or aggregated sub-slot(s) and slot. This unit may also be a unit for HARQ-ACK bit generation.

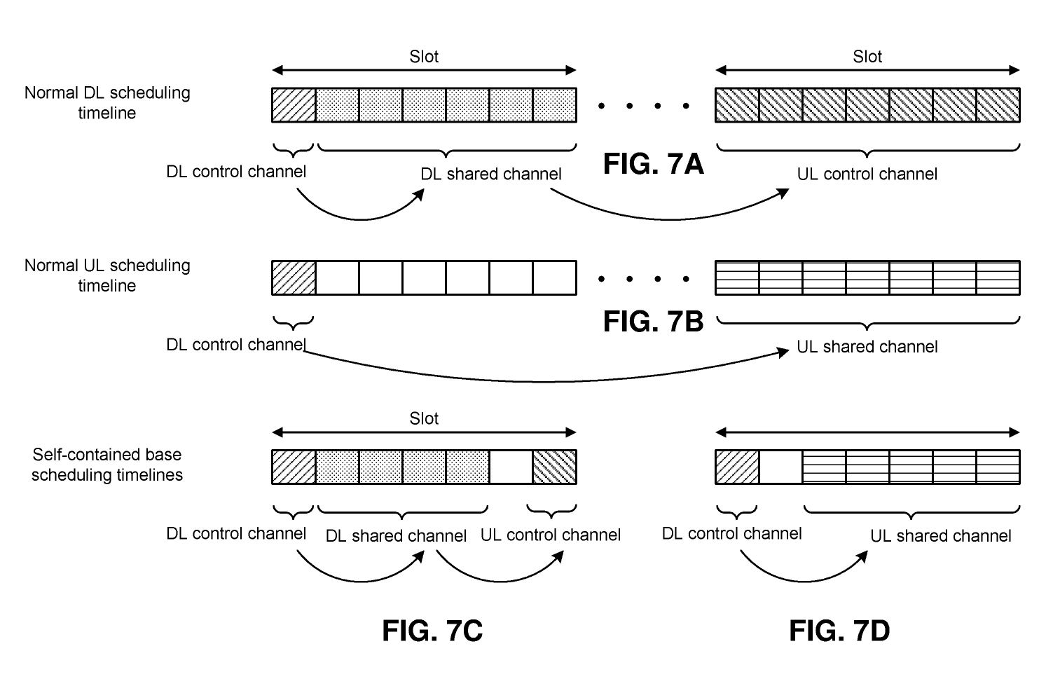

FIGS. 7A, 7B, 7C, and 7D show examples of scheduling timelines. For a normal DL scheduling timeline, DL control channels are mapped the initial part of a slot. The DL control channels schedule DL shared channels in the same slot. HARQ-ACKs for the DL shared channels (e.g., HARQ-ACKs each of which indicates whether or not transport block in each DL shared channel is detected successfully) are reported via UL control channels in a later slot. In this instance, a given slot may contain either one of DL transmission and UL transmission. For a normal UL scheduling timeline, DL control channels are mapped the initial part of a slot. The DL control channels schedule UL shared channels in a later slot. For these cases, the association timing (time shift) between the DL slot and the UL slot may be fixed or configured by higher layer signaling. Alternatively, it may be indicated by a physical layer control channel (e.g., the DL assignment DCI format, the UL grant DCI format, or another DCI format such as UE-common signaling DCI format which may be monitored in common search space).

For a self-contained base DL scheduling timeline, DL control channels are mapped the initial part of a slot. The DL control channels schedules DL shared channels in the same slot. HARQ-ACKs for the DL shared channels are reported UL control channels which are mapped at the ending part of the slot. For a self-contained base UL scheduling timeline, DL control channels are mapped the initial part of a slot. The DL control channels schedules UL shared channels in the same slot. For these cases, the slot may contain DL and UL portions, and there may be a guard period between the DL and UL transmissions. The use of self-contained slot may be upon a configuration of self-contained slot. Alternatively, the use of self-contained slot may be upon a configuration of the sub-slot. Yet alternatively, the use of self-contained slot may be upon a configuration of shortened physical channel (e.g., PDSCH, PUSCH, PUCCH, etc.).

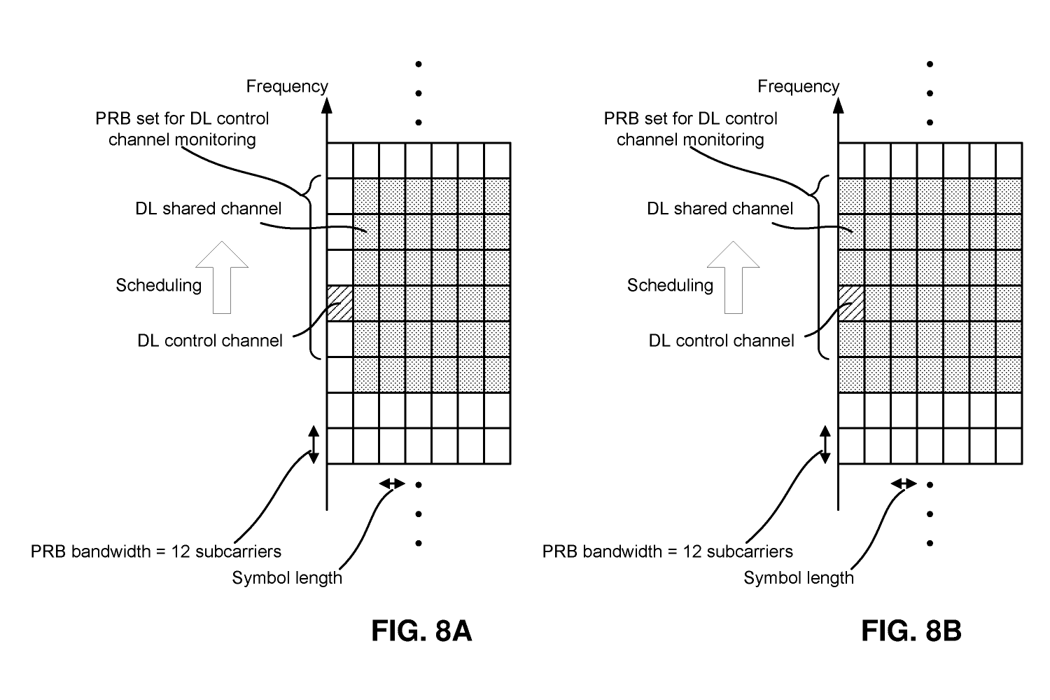

FIGS. 8A and 8B show examples of DL control channel monitoring regions. One or more sets of PRB(s) may be configured for DL control channel monitoring. For example, a control resource set is, in the frequency domain, a set of PRBs within which the UE attempts to blindly decode downlink control information, where the PRBs may or may not be frequency contiguous, a UE may have one or more control resource sets, and one DCI message may be located within one control resource set. In frequency-domain, a PRB is the resource unit size (may or may not including DM-RS) for control channel. DL shared channel may start at a later OFDM symbol than the one(s) which carries the detected DL control channel. Alternatively, the DL shared channel may start at or an earlier OFDM symbol than the last OFDM symbol which carries the detected DL control channel. For example, dynamic reuse of at least part of resources in the control resource sets for data for the same or a different UE, at least in the frequency domain may be supported.

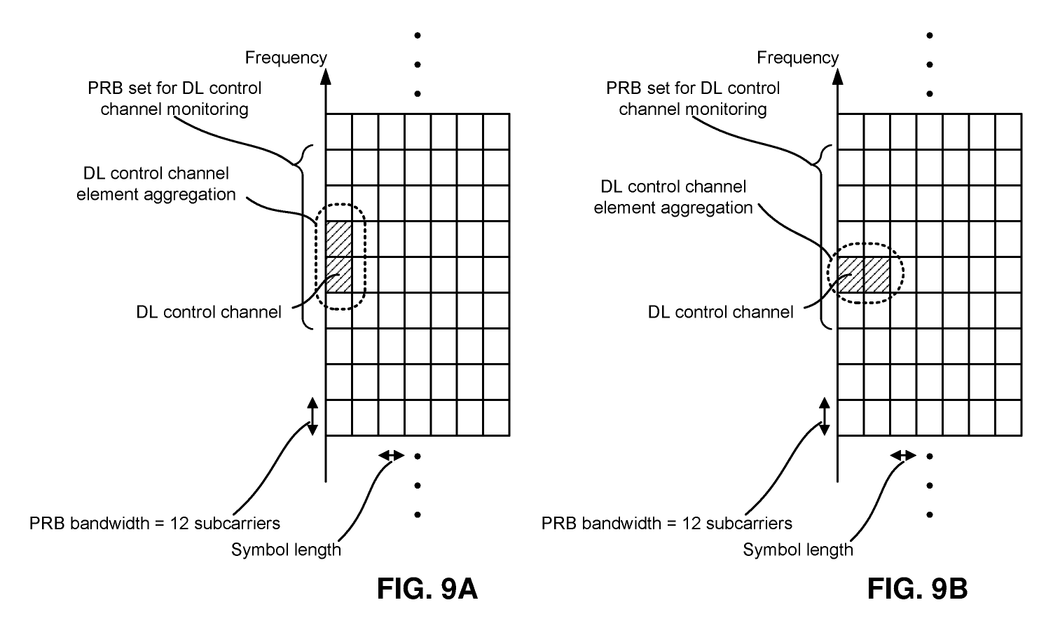

FIGS. 9A and 9B show examples of DL control channel which consists of more than one control channel elements. When the control resource set spans multiple OFDM symbols, a control channel candidate may be mapped to multiple OFDM symbols or may be mapped to a single OFDM symbol. One DL control channel element may be mapped on REs defined by a single PRB and a single OFDM symbol. If more than one DL control channel elements are used for a single DL control channel transmission, DL control channel element aggregation may be performed. The number of aggregated DL control channel elements is referred to as DL control channel element aggregation level. The DL control channel element aggregation level may be 1 or 2 to the power of an integer. The gNB may inform UE of which control channel candidates are mapped to each subset of OFDM symbols in the control resource set. If one DL control channel is mapped to a single OFDM symbol and does not span multiple OFDM symbols, the DL control channel element aggregation is performed within an OFDM symbol, namely multiple DL control channel elements within an OFDM symbol are aggregated. Otherwise, DL control channel elements in different OFDM symbols can be aggregated.

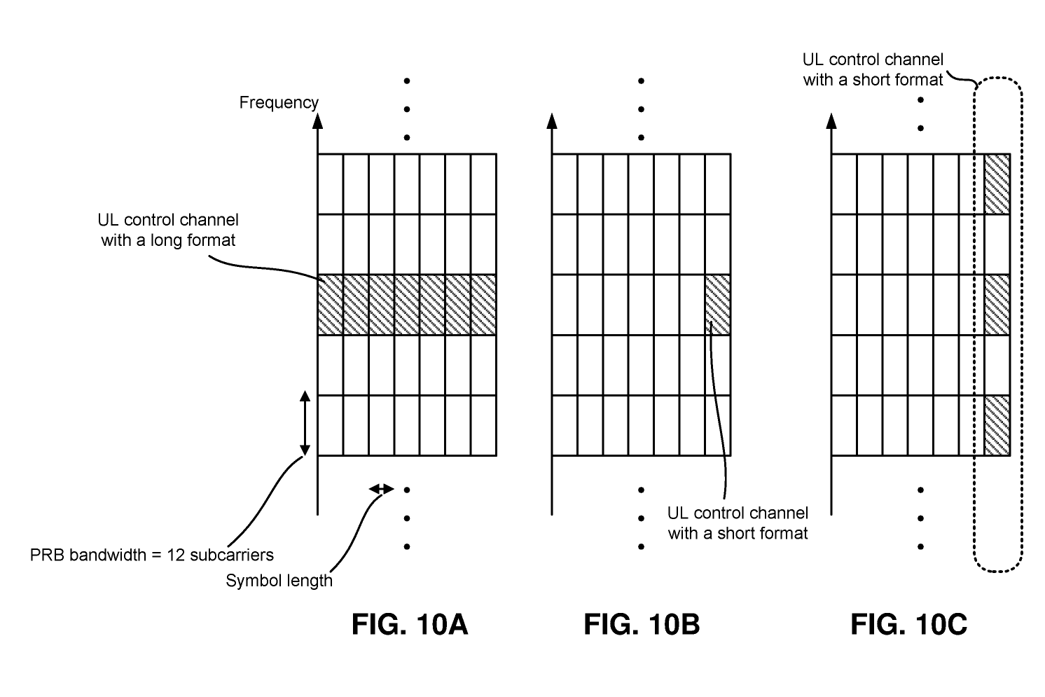

FIGS. 10A, 10B, and 10C show examples of UL control channel structures. UL control channel may be mapped on REs which are defined by a PRB and a slot in frequency and time domains, respectively. This UL control channel may be referred to as a long format (or just the 1st format). UL control channels may be mapped on REs on a limited OFDM symbols in time domain. This may be referred to as a short format (or just the 2nd format). The UL control channels with a short format may be mapped on REs with in a single PRB. Alternatively, the UL control channels with a short format may be mapped on REs with in multiple PRBs. For example, interlaced mapping may be applied, namely the UL control channel may be mapped to every N PRBs (e.g., 5 PRBs or 10 PRBs) within a system bandwidth.

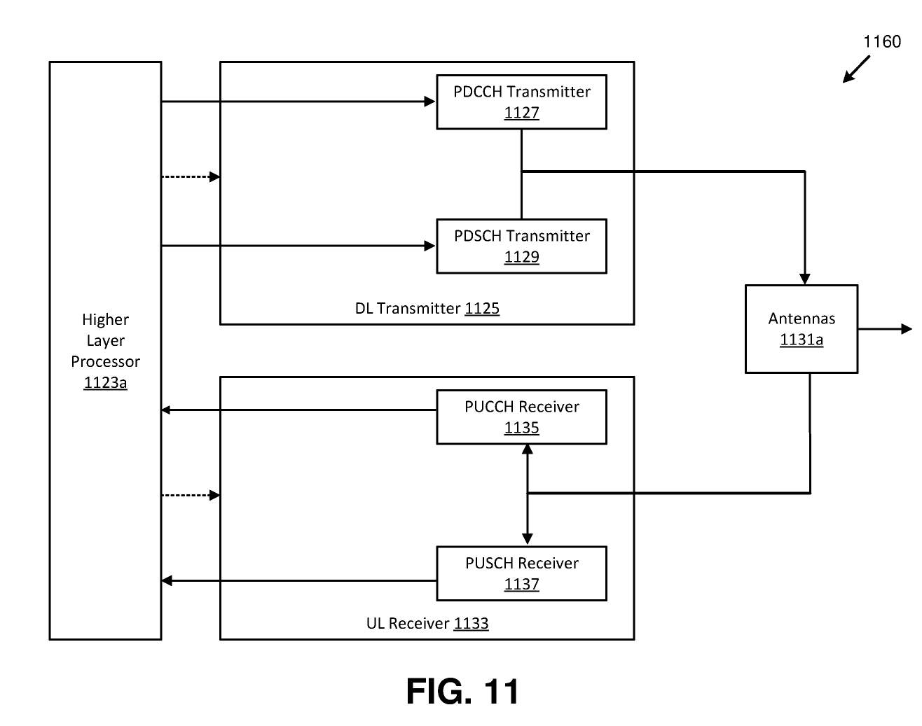

FIG. 11 is a block diagram illustrating one implementation of a base station (e.g., a Gnb). In FIG. 11, a gNB 1160 may substantially correspond to the gNB 160 in FIG. 1. As shown in FIG. 11, the gNB 1160 may include a higher layer processor 1123a, a DL transmitter 1125, a UL receiver 1133, and antennas 1131a. The DL transmitter 1125 may include a PDCCH transmitter 1127 and a PDSCH transmitter 1129. The UL receiver 1133 may include a PUCCH receiver 1135 and a PUSCH receiver 1137. The higher layer processor 1123a may manage physical layer's behaviors (the DL transmitter 1125's and the UL receiver 1133's behaviors) and provide higher layer parameters to the physical layer. The higher layer processor 1123a may obtain transport blocks from the physical layer. The higher layer processor 1123a may send/acquire higher layer messages such as an RRC message and MAC message to/from a UE's higher layer. The higher layer processor 1123a may provide the PDSCH transmitter 1129 transport blocks and provide the PDCCH transmitter 1127 transmission parameters related to the transport blocks. The UL receiver 1133 may receive multiplexed uplink physical channels and uplink physical signals via receiving antennas 1131a and de-multiplex them. The PUCCH receiver 1135 may provide the higher layer processor UCI. The PUSCH receiver 1137 may provide the higher layer processor received transport blocks.

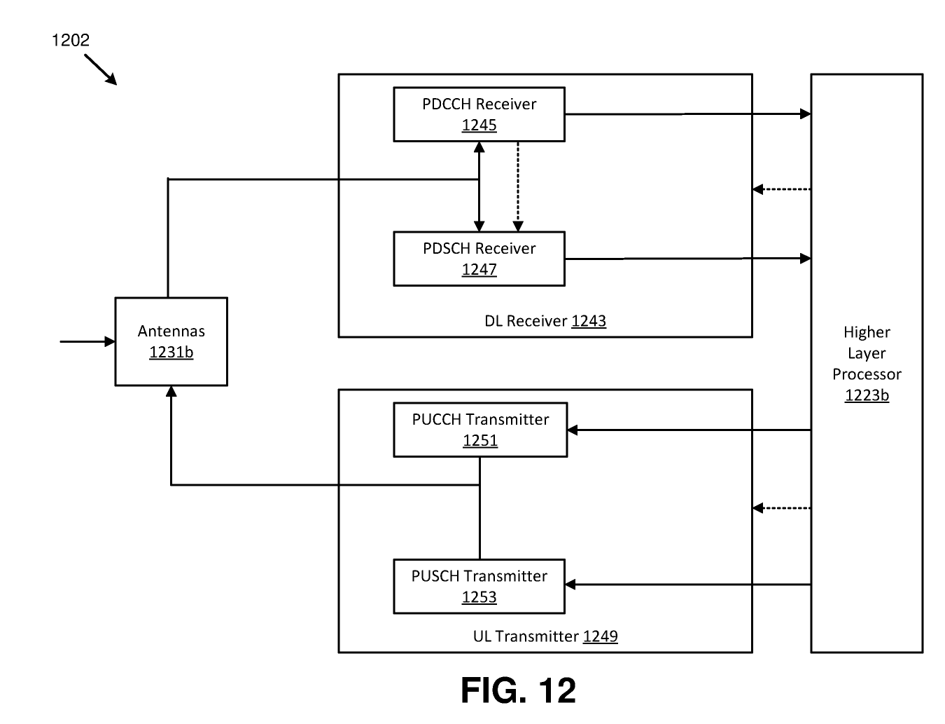

FIG. 12 is a block diagram illustrating one implementation of a UE. In FIG. 12, a UE 1202 may substantially correspond to the UE 102 in FIG. 1. As shown in FIG. 12, the UE 1202 may include a higher layer processor 1223b, a UL transmitter 1249, a DL receiver 1243, and antennas 1231b. The UL transmitter 1249 may include a PUCCH transmitter 1251 and a PUSCH transmitter 1253. The DL receiver 1243 may include a PDCCH receiver 1245 and a PDSCH receiver 1247. The higher layer processor 1223b may manage physical layer's behaviors (the UL transmitter 1249's and the DL receiver 1243's behaviors) and provide higher layer parameters to the physical layer. The higher layer processor 1223b may obtain transport blocks from the physical layer. The higher layer processor 1223b may send/acquire higher layer messages such as an RRC message and MAC message to/from a UE's higher layer. The higher layer processor 1223b may provide the PUSCH transmitter 1253 transport blocks and provide the PUCCH transmitter 1251 UCI. The DL receiver 1243 may receive multiplexed downlink physical channels and downlink physical signals via receiving antennas 1231b and de-multiplex them. The PDCCH receiver 1245 may provide the higher layer processor 1223b DCI. The PDSCH receiver 1247 may provide the higher layer processor 1223b received transport blocks.

It should be noted that names of physical channels described herein are examples. The other names such as “NRPDCCH, NRPDSCH, NRPUCCH and NRPUSCH” or the like can be used.

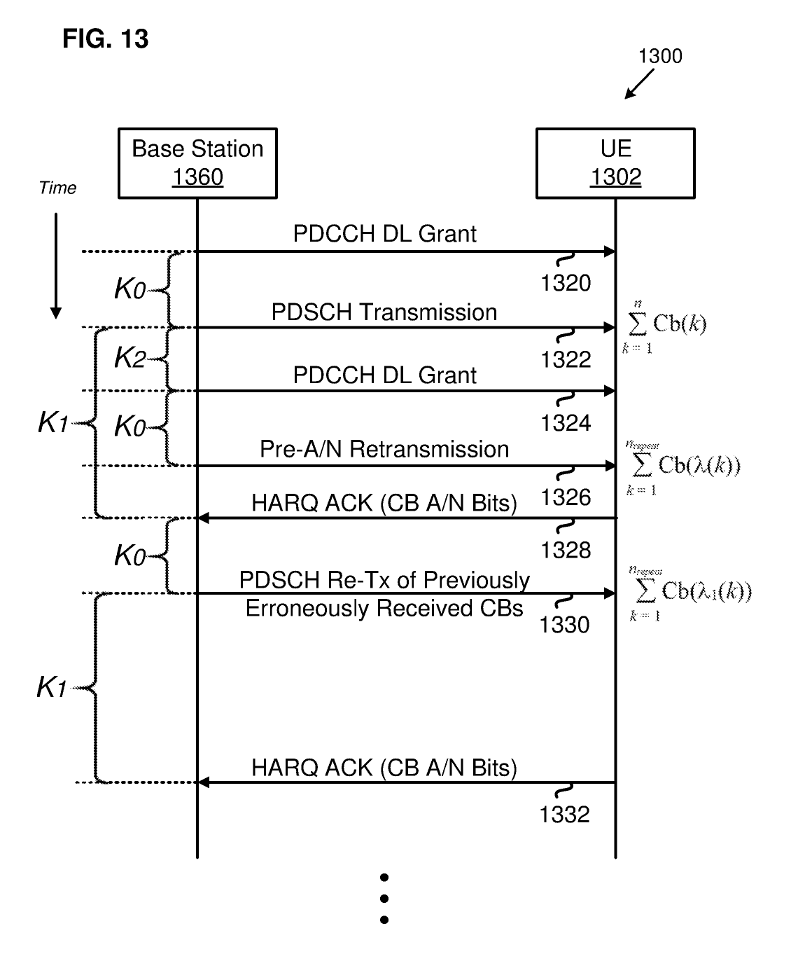

FIG. 13 is a diagram illustrating signal flow and timing for CBG-based HARQ (re)transmission, in accordance with an implementation of the present application. In the present implementation, a base station 1360 may communicate with a UE 1302. The UE 1302 and the base station 1360 may substantially correspond to the UE 102 and the gNB 160, respectively, in FIG. 1.

In action 1320, the base station 1360 transmits a DL grant (or a DL assignment) to the UE 1302 over a PDCCH. The DL grant may include Downlink Control Information (DCI), which may include information relating to the downlink resource allocation in a PDSCH, and information relating to a Modulation and Coding Scheme (MCS) for the PDSCH. In some implementations, a plurality of DCI formats may be defined for transmission of the DCI, where a field for the DCI may be defined in a DCI format and mapped to an information bit.

In the present implementation, the DCI in the DL grant includes scheduling DCI for a CBG-based transmission (scheduling DCI for short). The scheduling DCI may include one or more timing indicators indicating one or more delays among various signalings related to the CBG-based (re)transmission. For example, the scheduling DCI may include a first timing indicator indicating a first delay, K₀, between the DL grant for the CBG-based transmission and the CBG-based transmission. The scheduling DCI may include a second timing indicator indicating a second delay, K₁ between the CBG-based transmission and a hybrid automatic repeat request acknowledgement (HARQ-ACK) for the CBG-based transmission. The scheduling DCI may also include a third timing indicator indicating a third delay, K₂, between the CBG-based transmission and another DL grant for a pre-Acknowledgement/Non-Acknowledgement (pre-A/N) retransmission of the CBG. The CBG-based transmission may be initially transmitted as Σₖ₌₁ⁿ Cb (k) and on subsequent retransmissions as Σₖ₌₁ⁿ^{ᵣₑₚₑₐₜ}^{(k)} Cb(λⱼ(k)), where λⱼ(k) denotes the particular set of nᵣₑₚₑₐᵣ(k) codeblocks retransmitted on the j-th retransmission.

In the present implementation, the delays K₀, K₁, and K₂, or their equivalents, are configured by the base station 1360, and indicated to the UE 1302, for example, in the scheduling DCI over the PDCCH used to transmit the DL grant in action 1320.

In action 1320, the base station 1360 may configure the first, second, and third timing indicators indicating the delays K₀, K₁, and K₂, respectively, or their equivalents, and transmit the scheduling DCI having the delays K₀, K₁, and K₂ in the scheduling DCI, for example, over the PDCCH used to transmit the DL grant.

In action 1322, the base station 1360 transmits DL data to the UE 1302 through a PDSCH in the DL resource indicated in the DL grant. As shown in the diagram 1300, there is a delay (e.g., K₀) between the DL grant in action 1320 and the corresponding DL transmission in action 1322.

In action 1324, the base station 1360 transmits another DL grant to the UE 1302 over a PDCCH, where the DL grant indicates that a pre-A/N retransmission (also referred to as an A/N-less retransmission) will be transmitted. A pre-A/N retransmission in the present implementation is a retransmission of at least a portion of the codeblocks of the CBG transmitted to the UE 1302 in the initial transmission (e.g., in action 1322), before the base station 1360 receives an acknowledgement (ACK) or a non/negative-acknowledgement (NACK) (ACK/NACK or A/N) for the initial transmission of the downlink data (e.g., the CBG). The ACK and NACK of the downlink data may also be referred to as a hybrid automatic repeat request acknowledgement (HARQ-ACK) (or HARQ feedback).

In the present implementation, since there is configuration or some other instantiating of retransmission prior to the HARQ-ACK, there is a delay, K₂, between the time that the PDSCH transmission is enabled in action 1322 and the DL grant indicating that the pre-A/N retransmission will be transmitted in action 1324. It is important to note that, by including the delay, K₂, in the scheduling DCI in the DL grant in action 1320, the configured timing for the DL grant for the pre-A/N retransmission is known to the UE 1302 after the UE 1302 receives the initial DL grant in action 1320. Thus, the UE 1302 may schedule for the reception of the DL grant for the pre-A/N retransmission in advance.

In one implementation, the scheduling DCI, having timing indicators indicating the delays K₀, K₁, and K₂, may be communicated to the UE 1302 through radio resource control (RRC) signaling (e.g., using an RRC configuration). In another implementation, the scheduling DCI may be communicated to the UE 1302 through medium access control (MAC) signaling (e.g., using a MAC control element (CE)).

In action 1326, the base station 1360 retransmits at least a portion of the codeblocks of the CBG transmitted to the UE 1302 in the initial transmission (e.g., in action 1322), before receiving a HARQ-ACK response from the UE 1302. The pre-A/N retransmission is transmitted to the UE 1302 over a PDSCH in the DL resource indicated in the DL grant in action 1324.

In one implementation, the delay between the DL grant in action 1324 and the corresponding pre-A/N retransmission in action 1326, may be K₀. In other implementations, the delay between the DL grant in action 1324 and the corresponding pre-A/N retransmission in action 1326, may be greater or less than K₀.

In action 1328, the UE 1302 transmits a HARQ response, such as a HARQ ACK/NACK message, to the base station 1360. For example, the HARQ response may include A/N bits of the codeblocks received by the UE 1302 in action 1322 and/or action 1326. As shown in the diagram 1300, there is a delay, K₁, between the CBG-based DL transmission in action 1322 and the HARQ-ACK for the CBG-based transmission in action 1328.

It is important to note that, by including the time delay, K₁, in the scheduling DCI in the DL grant in action 1320, the configured timing for sending the HARQ-ACK is known to the UE 1302 after the UE 1302 receives the DL grant in action 1320. Thus, the UE 1302 may schedule for the transmission of the HARQ-ACK in advance. After receiving the HARQ-ACK, in action 1330, the base station 1360 retransmits to the UE 1302 the previously erroneously received codeblocks based on the codeblock A/N bits indicated in the HARQ-ACK.

In one implementation, the delay between the HARQ-ACK in action 1328 and the corresponding retransmission of previously erroneously received codeblock(s) in action 1330, may be delay K₀. In other implementations, the delay between the HARQ-ACK in action 1328 and the corresponding retransmission of previously erroneously received codeblock(s) in action 1330, may be greater or less than K₀.

In action 1332, after a delay, K₁, the base station 1360 may receive a HARQ-ACK indicating A/N bits of the codeblocks received by the UE 1302 in action 1330.

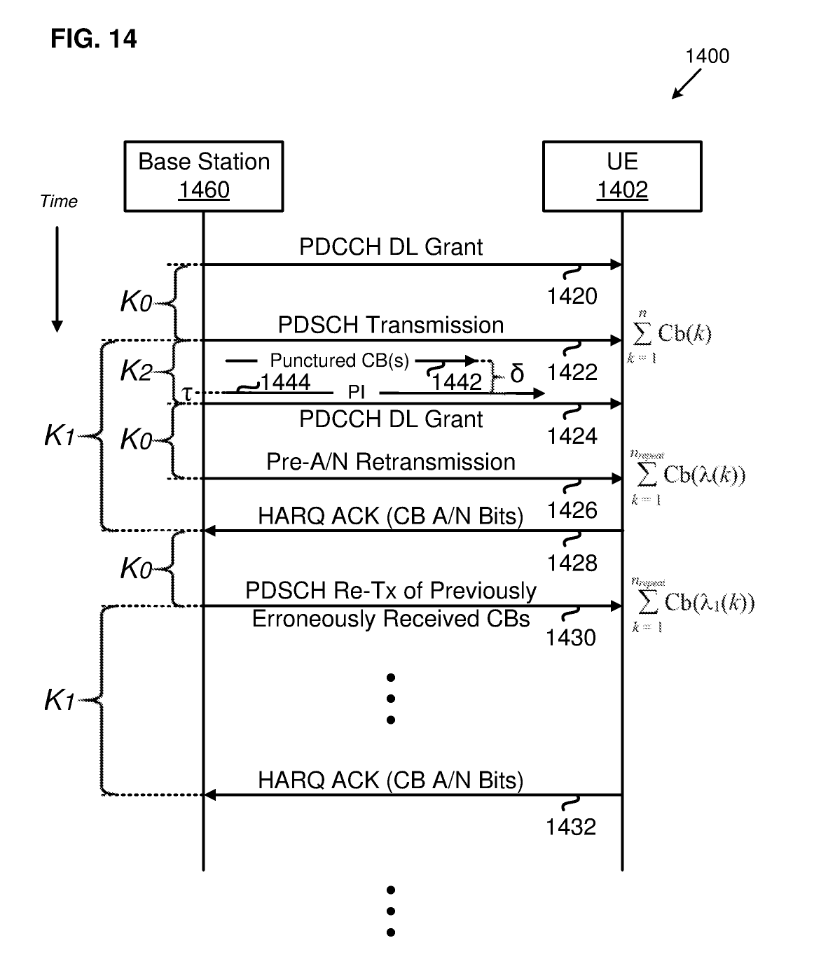

FIG. 14 is a diagram illustrating signal flow and timing for CBG-based HARQ (re)transmission with a preemption indication (PI), in accordance with an example implementation of the present application. In the present implementation, a base station 1460 may communicate with a UE 1402. The UE 1402 and the base station 1460 may substantially correspond to the UE 102 and the gNB 160, respectively, in FIG. 1.

According to the present implementation, in addition to configuring the scheduling DCI and transmitting the scheduling DCI to the UE, the base station may configure DCI for preemption indication (DCI for PI), and transmit the DCI for PI to the UE, for example, over a PDCCH. The preemption indication is configured by the base station, and transmitted to the UE to indicate what resources were impacted, for example, by prioritized transmissions. As an example, when a URLLC transmission is required for the downlink, and other resources are not available, a semi-persistently scheduled enhanced mobile broadband (eMBB) transmission may be pre-empted or punctured, where the base station scheduler may pre-empt or puncture transmission of one or more subframes of the eMBB transmission with an ultra-reliable low latency communication (URLLC) transmission that may or may not be targeted to the UE receiving the eMBB transmission. In this example, (e.g., the URLLC transmission puncturing the eMBB transmission), it would be beneficial if the eMBB-receiving UE could receive a PI from the base station indicating, for example, the timing of the resources impacted (e.g., frames were punctured by the URLLC signal), such that the eMBB-receiving UE would know not to use the URLLC transmission for decoding eMBB messages. As a result, the decoding process of the eMBB messages and the performance thereof would not be significantly affected by the URLLC transmission.

According to implementations of the present application, a PI may include a specific sequence of bits or specific reference signals to indicate to the UE the timing of resource(s) impacted, such that the UE may ignore the impacted data or attempt to demodulate and decode the impacted data using the appropriate demodulation format and decoding scheme. For example, upon configuration by the base station, the timing of resource(s) impacted may be signaled using one or more of the following approaches. In one approach, when the PI is in the same slot as the corresponding puncturing, the starting slot time may be implicitly indicated by the DCI. In another approach, the base station may configure a delay (e.g., δ) between the PI and the resource(s) impacted (e.g., affected slot(s)). In another approach, a timing reference may be included in the DCI, and an indication of affected areas may be included in a bitmap. The impacted UE may monitor the control channel for indication of the PI (e.g., mini-slot transmission). With knowledge of the preemption (e.g., the impacted data resources), the UE may flush the buffer corresponding to the impacted data, or assign a likelihood of “0” to those impacted resources for the purposes of decoding.

In the diagram 1400, actions 1420, 1422, 1424, 1426, 1428, 1430, and 1432 may be substantially similar to actions 1320, 1322, 1324, 1326, 1328, 1330, and 1332, respectively, in FIG. 13. Thus, the descriptions of the actions 1420, 1422, 1424, 1426, 1428, 1430, and 1432 are omitted for brevity.

As shown in FIG. 14, in action 1442, the UE 1402 receives one or more punctured PDSCH codeblocks (e.g., slot(s) or mini-slot(s)). In action 1444, the UE 1402 receives a PI in slot τ, where the PI may include a delay, δ, between the punctured PDSCH (mini)slot(s) received in action 1442 and the reception of the PI. The PI may also include the impacted (mini)slot(s). As such, the UE 1402 may flush the buffer corresponding to the impacted (mini)slot(s), or assign a likelihood of “0” to those impacted resources for the purposes of decoding.

In the present implementation, the timing relationships between the delay 6 and DL grants may be specified in the PI in action 1444. As shown in FIG. 14, following the PI (e.g., over a PDCCH), in action 1424, the base station 1460 transmits a DL grant to the UE 1402 over a PDCCH, where the DL grant indicates that a pre-A/N retransmission will be transmitted in action 1426.

In the present implementation, the PI in the action 1444 is transmitted over a PDCCH, and may contain information relevant to the DL grant in action 1424. In one implementation, the PI may include a pointer to the DL grant to save blind decoding. In one implementation, the PI may include a timing reference indicating the delay between the PI and the next DL grant.

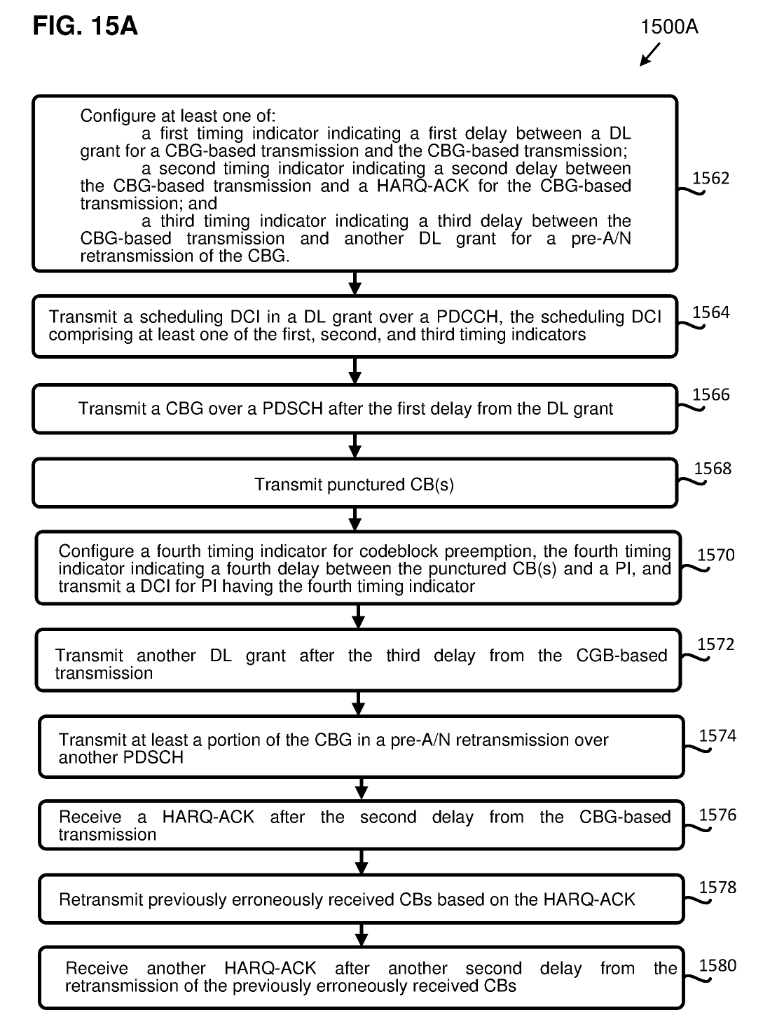

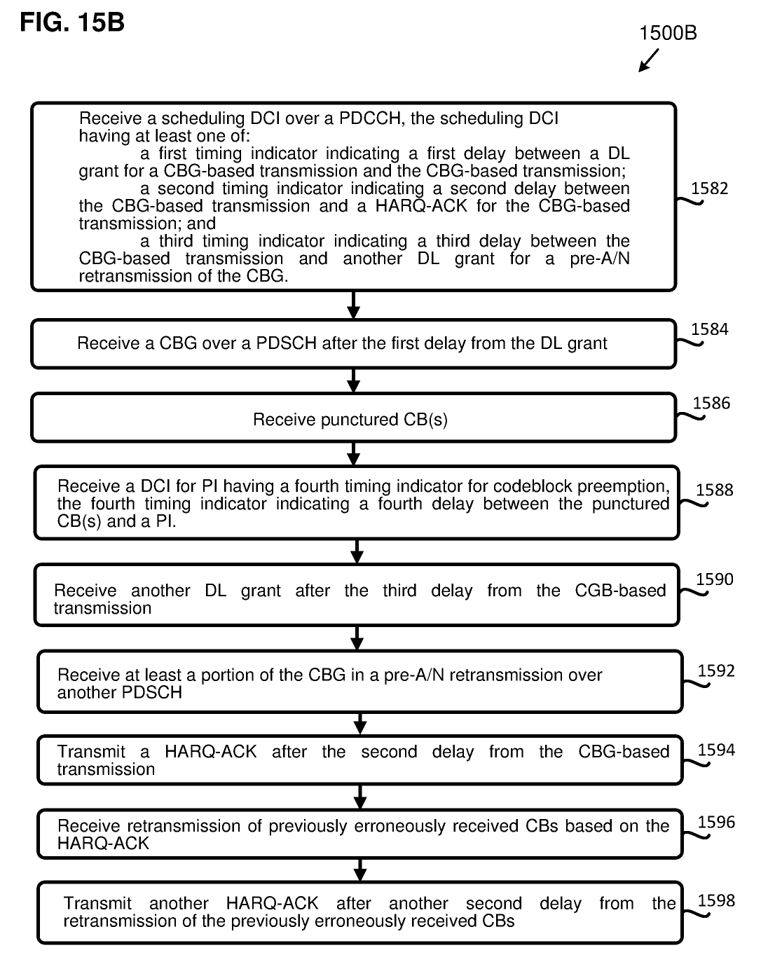

Turning to FIG. 15A, FIG. 15A is a flowchart illustrating a method by a base station, in accordance with an implementation of the present application. In the present implementation, the base station may correspond to the base station 1460 in FIG. 14.

As shown in the flowchart 1500A, in action 1562, the base station may configure at least one of: a first timing indicator indicating a first delay, K₀, between a DL grant for a CBG-based transmission and the CBG-based transmission; a second timing indicator indicating a second delay, K₁, between the CBG-based transmission and a HARQ-ACK for the CBG-based transmission; and a third timing indicator indicating a third delay, K₂, between the CBG-based transmission and another DL grant for a pre-A/N retransmission of the CBG.

In action 1564, the base station transmits a scheduling DCI in a DL grant over a PDCCH, the scheduling DCI having at least one of the first, second, and third timing indicators (e.g., with respective delays K₀, K₁, and K₂, or their equivalents). With reference to FIG. 14, in action 1420, the base station 1460 transmits the scheduling DCI having the delays K₀, K₁, and K₂, or their equivalents, in the scheduling DCI, for example, over the PDCCH used to transmit the DL grant.

In action 1566, the base station transmits a CBG over a PDSCH after the first delay, K₀, from the DL grant in action 1564. With reference to FIG. 14, the base station 1460 transmits DL data (e.g., CBG) to the UE 1402 through a PDSCH in the DL resource indicated in the DL grant in action 1420. As shown in the diagram 1400, there is a delay (e.g., K₀) between the DL grant in action 1420 and the corresponding DL data transmission in action 1422.

In action 1568, the base station transmits one or more punctured PDSCH codeblocks. With reference to FIG. 14, the base station 1460 transmits one or more punctured PDSCH codeblocks (e.g., slot(s) or mini-slot(s)).

In action 1570, the base station configures a fourth timing indicator for codeblock preemption, the fourth timing indicator indicating a fourth delay, δ, between the one or more punctured PDSCH codeblocks and a PI, and transmits a DCI for PI having the fourth timing indicator. With reference to FIG. 14, in action 1444, the base station 1460 transmits a PI in slot T, where the PI may include a delay, δ, between the punctured PDSCH (mini)slot(s) received in action 1442 and the reception of the PI in action 1444. The PI may also include the impacted (mini)slot(s). As such, the UE 1402 may flush the buffer corresponding to the impacted (mini)slot(s), or assign a likelihood of “0” to those impacted resources for the purposes of decoding.

In action 1572, the base station transmits another DL grant after the third delay, K₂, from the CBG-based transmission in action 1566. With reference to FIG. 14, in action 1424, the base station 1460 transmits another DL grant to the UE 1402 over a PDCCH, where the DL grant indicates that a pre-A/N retransmission will be transmitted. The pre-A/N retransmission is a retransmission of at least a portion of the codeblocks of the CBG transmitted to the UE 1402 in the initial CBG-based transmission (e.g., in action 1422), before the base station 1460 receives a HARQ-ACK for the initial transmission of the downlink data (e.g., the CBG). In the present implementation, since there is configuration or some other instantiating of retransmission prior to the HARQ-ACK, there is a delay, K₂, between the time that the PDSCH transmission is enabled in action 1422 and the DL grant indicating that the pre-A/N retransmission will be transmitted in action 1424. It is important to note that, by including the delay, K₂, in the scheduling DCI in the DL grant in action 1420, the configured timing for the DL grant for the pre-A/N retransmission is known to the UE 1402 after the UE 1402 receives the initial DL grant in action 1420. Thus, the UE 1402 may schedule for the reception of the DL grant for the pre-A/N retransmission in advance. In one implementation, the scheduling DCI, having timing indicators indicating the delays K₀, K₁, and K₂, may be communicated to the UE 1402 through RRC signaling (e.g., using an RRC configuration). In another implementation, the scheduling DCI may be communicated to the UE 1402 through MAC signaling (e.g., using a MAC CE).

In action 1574, the base station transmits at least a portion of the CBG in a pre-A/N retransmission over another PDSCH. With reference to FIG. 14, in action 1426, the base station 1460 retransmits at least a portion of the codeblocks of the CBG transmitted to the UE 1402 in the initial transmission (e.g., in action 1422), before receiving a HARQ-ACK response from the UE 1402. The pre-A/N retransmission is transmitted to the UE 1402 over a PDSCH in the DL resource indicated in the DL grant in action 1424. In one implementation, the delay between the DL grant in action 1424 and the corresponding pre-A/N retransmission in action 1426, may be K₀. In other implementations, the delay between the DL grant in action 1424 and the corresponding pre-A/N retransmission in action 1426, may be greater or less than K₀.

In action 1576, the base station receives a HARQ-ACK after the second delay, K₁, from the CBG-based transmission. With reference to FIG. 14, in action 1428, the base station 1460 receives a HARQ-ACK from the UE 1402. For example, the HARQ response may include A/N bits of the codeblocks received by the UE 1402 in action 1422 and/or action 1426. As shown in the diagram 1400, there is a delay, K₁, between the CBG-based DL transmission in action 1422 and the HARQ-ACK for the CBG-based transmission in action 1428. It is important to note that, by including the time delay, K₁, in the scheduling DCI in the DL grant in action 1420, the configured timing for sending the HARQ-ACK is known to the UE 1402 after the UE 1402 receives the DL grant in action 1420. Thus, the UE 1402 may schedule for the transmission of the HARQ-ACK in advance.

In action 1578, the base station retransmits previously erroneously received codeblocks based on the HARQ-ACK. With reference to FIG. 14, in action 1430, the base station 1460 retransmits to the UE 1402 the previously erroneously received codeblocks based on the codeblock A/N bits indicated in the HARQ-ACK received in action 1428. In one implementation, the delay between the HARQ-ACK in action 1428 and the corresponding retransmission of previously erroneously received codeblock(s) in action 1430, may be delay K₀. In other implementations, the delay between the HARQ-ACK in action 1428 and the corresponding retransmission of previously erroneously received codeblock(s) in action 1430, may be greater or less than K₀.

In action 1580, the base station receives another HARQ-ACK after another second delay from the retransmission of the previously erroneously received CBs. With reference to FIG. 14, in action 1432, after a delay, K₁, the base station 1460 receives a HARQ-ACK indicating A/N bits of the codeblocks received by the UE 1302 in action 1430.

Turning to FIG. 15B, FIG. 15B is a flowchart illustrating a method by a UE, in accordance with an implementation of the present application. In the present implementation, the UE may correspond to the UE 1402 in FIG. 14.

As shown in the flowchart 1500B, in action 1582, the UE may receive a scheduling DCI in a DL grant over a PDCCH, the scheduling DCI includes at least one of: a first timing indicator indicating a first delay, K₀, between a DL grant for a CBG-based transmission and the CBG-based transmission; a second timing indicator indicating a second delay, K₁, between the CBG-based transmission and a HARQ-ACK for the CBG-based transmission; and a third timing indicator indicating a third delay, K₂, between the CBG-based transmission and another DL grant for a pre-A/N retransmission of the CBG. With reference to FIG. 14, the UE 1402 receives the scheduling DCI having the delays K₀, K₁, and K₂, or their equivalents, in the scheduling DCI, for example, over the PDCCH used to transmit the DL grant in action 1420.

In action 1584, the UE receives a CBG over a PDSCH after the first delay, K₀, from the DL grant in action 1582. With reference to FIG. 14, the UE 1402 receives DL data (e.g., CBG) from the base station 1460 through a PDSCH in the DL resource indicated in the DL grant in action 1420. As shown in the diagram 1400, there is a delay (e.g., K₀) between the DL grant in action 1420 and the corresponding DL data transmission in action 1422.

In action 1586, the UE receives one or more punctured PDSCH codeblocks. With reference to FIG. 14, the UE 1402 receives one or more punctured PDSCH codeblocks (e.g., slot(s) or mini-slot(s)) from the base station 1460.

In action 1588, the UE receives a DCI for PI having a fourth timing indicator for codeblock preemption, the fourth timing indicator indicating a fourth delay, δ, between the one or more punctured PDSCH codeblocks and a PI. With reference to FIG. 14, in action 1444, the UE 1402 transmits a PI in slot τ, where the PI may include a delay, δ, between the punctured PDSCH (mini)slot(s) received in action 1442 and the reception of the PI in action 1444. The PI may also include the impacted (mini)slot(s). As such, the UE 1402 may flush the buffer corresponding to the impacted (mini)slot(s), or assign a likelihood of “0” to those impacted resources for the purposes of decoding.

In action 1590, the UE receives another DL grant after the third delay, K₂, from the CBG-based transmission in action 1584. With reference to FIG. 14, in action 1424, the UE 1402 receives another DL grant from the base station 1460 over a PDCCH, where the DL grant indicates that a pre-A/N retransmission will be transmitted. The pre-A/N retransmission is a retransmission of at least a portion of the codeblocks of the CBG transmitted to the UE 1402 in the initial CBG-based transmission (e.g., in action 1422), before the base station 1460 receives a HARQ-ACK for the initial transmission of the downlink data (e.g., the CBG). In the present implementation, since there is configuration or some other instantiating of retransmission prior to the HARQ-ACK, there is a delay, K₂, between the time that the PDSCH transmission is enabled in action 1422 and the DL grant indicating that the pre-A/N retransmission will be transmitted in action 1424. It is important to note that, by including the delay, K₂, in the scheduling DCI in the DL grant in action 1420, the configured timing for the DL grant for the pre-A/N retransmission is known to the UE 1402 after the UE 1402 receives the initial DL grant in action 1420. Thus, the UE 1402 may schedule for the reception of the DL grant for the pre-A/N retransmission in advance. In one implementation, the scheduling DCI, having timing indicators indicating the delays K₀, K₁, and K₂, may be communicated to the UE 1402 through RRC signaling (e.g., using an RRC configuration). In another implementation, the scheduling DCI may be communicated to the UE 1402 through MAC signaling (e.g., using a MAC CE).

In action 1592, the UE receives at least a portion of the CBG in a pre-A/N retransmission over another PDSCH. With reference to FIG. 14, in action 1426, the UE 1402 receives the retransmission of at least a portion of the codeblocks of the CBG transmitted to the UE 1402 in the initial transmission (e.g., in action 1422), before transmitting a HARQ-ACK response to the base station 1460. The pre-A/N retransmission is transmitted to the UE 1402 over a PDSCH in the DL resource indicated in the DL grant in action 1424. In one implementation, the delay between the DL grant in action 1424 and the corresponding pre-A/N retransmission in action 1426, may be K₀. In other implementations, the delay between the DL grant in action 1424 and the corresponding pre-A/N retransmission in action 1426, may be greater or less than K₀.

In action 1594, the UE transmits a HARQ-ACK after the second delay, K₁, from the CBG-based transmission. With reference to FIG. 14, in action 1428, the UE 1402 transmits a HARQ-ACK to the base station 1460. For example, the HARQ response may include A/N bits of the codeblocks received by the UE 1402 in action 1422 and/or action 1426. As shown in the diagram 1400, there is a delay, K₁, between the CBG-based DL transmission in action 1422 and the HARQ-ACK for the CBG-based transmission in action 1428. It is important to note that, by including the time delay, K₁, in the scheduling DCI in the DL grant in action 1420, the configured timing for sending the HARQ-ACK is known to the UE 1402 after the UE 1402 receives the DL grant in action 1420. Thus, the UE 1402 may schedule for the transmission of the HARQ-ACK in advance.

In action 1596, the UE 1402 receives the retransmission of previously erroneously received codeblocks based on the HARQ-ACK. With reference to FIG. 14, in action 1430, the UE 1402 receives the retransmission by the base station 1460 of the previously erroneously received codeblocks based on the codeblock A/N bits indicated in the HARQ-ACK in action 1428. In one implementation, the delay between the HARQ-ACK in action 1428 and the corresponding retransmission of previously erroneously received codeblock(s) in action 1430, may be delay K₀. In other implementations, the delay between the HARQ-ACK in action 1428 and the corresponding retransmission of previously erroneously received codeblock(s) in action 1430, may be greater or less than K₀.

In action 1598, the UE 1402 transmits another HARQ-ACK after another second delay from the reception of retransmission of the previously erroneously received CBs. With reference to FIG. 14, in action 1432, after a delay, K₁, the UE 1402 transmits a HARQ-ACK indicating A/N bits of the codeblocks received by the UE 1302 in action 1430.

According to one implementation of the present application, the scheduling DCI and the DCI for PI may be configured separately by the base station. According to another implementation of the present application, the scheduling DCI and the DCI for PI may be jointly configured by the base station, or related to each other.

In one implementation, the scheduling DCI may contain information indicating when, where and/or how to obtain the DCI for PI. The scheduling DCI may contain a time-domain information (e.g., slot index/offset, mini-slot index/position/length/offset) indicating the timing for the UE to monitor the DCI for PI. For example, the UE receives the scheduling DCI at timing (e.g., slot, subframe, mini-slot, OFDM symbol) index n, and the scheduling DCI indicates the timing delay between the scheduling DCI and the DCI for PI, which is denoted by D1 (e.g., D1≥0), then the UE monitors the corresponding the DCI for PI at timing index n+D1.

The scheduling DCI may contain information of search space for the DCI for PI. For example, the UE receives the scheduling DCI, which indicates the search space for DCI for PI monitoring. The UE then monitors the corresponding DCI for PI at the indicated search space.

In yet another implementation, a set of multiple PDCCH resources (e.g., multiple timings, multiple search spaces) for the DCI for PI may be RRC configured. The scheduling DCI may contain information indicating the choice from the set for the corresponding DCI for PI.

TABLE 1
Time delay between scheduling DCI and DCI for PI field in the scheduling
DCI

| Field “delay between scheduling DCI and | |
|---|---|
| DCI for PI” | Timing delay |
| 00 | Delay value 1 |
| 01 | Delay value 2 |
| 10 | Delay value 3 |
| 11 | Delay value 4 |

TABLE 2
Search space for DCI for PI field in the scheduling DCI

| Field “search space for DCI for PI” | Search space |
|---|---|
| 00 | Search space 1 |
| 01 | Search space 2 |
| 10 | Search space 3 |
| 11 | Search space 4 |

In some implementations, instead of or in addition to using the fields shown in Table 1 and/or Table 2, the scheduling DCI may reuse other fields (e.g., NDI, RV, MCS, RB assignment, TPC command for PUCCH, antenna port(s), scrambling identity, the number of layers, SRS request, PDSCH RE mapping, PDSCH start position, quasi-co-location, HARQ-ACK resource offset, interference presence, HARQ process number, PDSCH timing offset, HARQ timing offset, etc.) to indicate the time delay or search space for the DCI for PI.

In some implementations, the timing delay between the scheduling DCI and the DCI for PI and/or the search space for DCI for PI monitoring may be RRC configured, indicated by other L1 signaling (e.g., PDCCH, DCI, UL grant) or L2 signaling (e.g., MAC CE), or determined by other parts of specification.

The scheduling DCI may contain information indicating whether the UE needs to monitor the corresponding DCI for PI or not. For example, the scheduling DCI may include information (e.g., 1-bit) indicating whether the UE needs to monitor the DCI for PI at the configured search space and/or the configured timing.

In another example, when no additional information is included in the scheduling DCI to indicate any information for the DCI for PI, the UE may need to continuously monitor the corresponding DCI for PI at the configured search space and the configured timing after detecting the scheduling DCI successfully.

In another implementation, the DCI for PI may contain information indicating when, where and/or how to obtain the scheduling DCI. The DCI for PI may contain a time-domain information (e.g., slot index/offset, mini-slot index/position/length/offset) indicating the timing for the UE to monitor the scheduling DCI. For example, the UE receives the DCI for PI at timing (e.g., slot, subframe, mini-slot, OFDM symbol) index n, and the DCI for PI indicates the timing delay between the DCI for PI and the scheduling DCI, which is denoted by D2 (e.g., D2≥0), then the UE monitors the corresponding DCI at timing index n+D2.

The DCI for PI may contain information of search space for the scheduling DCI. For example, the UE receives the DCI for PI, which indicates the search space for the scheduling DCI monitoring. The UE then monitors the corresponding scheduling DCI at the indicated search space.

In yet another implementation, a set of multiple PDCCH resources (e.g., multiple timings, multiple search spaces) for the scheduling DCI are RRC configured. The DCI for PI may contain information indicating the choice from the set for the corresponding scheduling DCI.

TABLE 3
Time delay between DCI for PI and scheduling DCI field in the DCI for PI

| Field “delay between DCI for PI and | |
|---|---|
| scheduling DCI” | Timing delay |
| 00 | Delay value 1 |
| 01 | Delay value 2 |
| 10 | Delay value 3 |
| 11 | Delay value 4 |

TABLE 4
Search space for scheduling DCI field in the DCI for PI

| Field “search space for scheduling DCI” | Search space |
|---|---|
| 00 | Search space 1 |
| 01 | Search space 2 |
| 10 | Search space 3 |
| 11 | Search space 4 |

In some implementations, instead of or in addition to using the fields shown in Table 3 and/or Table 4, the DCI for PI may reuse other fields (e.g., NDI, RV, MCS, RB assignment, TPC command for PUCCH, antenna port(s), scrambling identity, the number of layers, SRS request, PDSCH RE mapping, PDSCH start position, quasi-co-location, HARQ-ACK resource offset, interference presence, HARQ process number, PDSCH timing offset, HARQ timing offset, etc.) to indicate the time delay or search space for the scheduling DCI.

In some implementations, the timing delay between the DCI for PI and the scheduling DCI and/or the search space for scheduling DCI monitoring may be RRC configured, indicated by other L1 signaling (e.g., PDCCH, DCI, UL grant) or L2 signaling (e.g., MAC CE), or determined by other parts of specification.

The DCI for PI may contain information indicating whether the UE needs to monitor the corresponding scheduling DCI or not. For example, the DCI for PI may include information (e.g., 1-bit) indicating whether the UE needs to monitor the scheduling DCI at the configured search space and/or the configured timing.

In yet another example, when no additional information is included in the DCI for PI to indicate any information for the scheduling DCI, then UE may need to continuously monitor the corresponding scheduling DCI at the configured search space and the configured timing after detecting the DCI for PI successfully.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, electrically erasable programmable read-only memory (EEPROM), CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

A program running on the gNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB 160 and the UE 102 according to the systems and methods described above may be realized as an LSI that is a typical integrated circuit. Each functional block of the gNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device (e.g., a gNB) and the terminal device (e.g., a UE) used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

What is claimed is:

1. A method comprising:
configuring, by a base station, at least one of:
a first timing indicator indicating a first delay between a downlink (DL) grant for a codeblock group (CBG)-based transmission and the CBG-based transmission;
a second timing indicator indicating a second delay between the CBG-based transmission and a hybrid automatic repeat request acknowledgement (HARQ-ACK) for the CBG-based transmission; and
a third timing indicator indicating a third delay between the CBG-based transmission and another DL grant for a pre-Acknowledgement/Non-Acknowledgement (pre-A/N) retransmission of the CBG; and
transmitting, by the base station, a scheduling downlink control information (DCI) over a physical downlink control channel (PDCCH), the scheduling DCI comprising at least one of the first, second, and third timing indicators.

2. The method of claim 1, further comprising at least one of:
transmitting, by the base station, the DL grant;
transmitting, by the base station, a CBG over a physical downlink shared channel (PDSCH) after the first delay from the DL grant;
transmitting, by the base station, the another DL grant after the third delay from the CBG-based transmission; and
receiving, by the base station, the HARQ-ACK after the second delay from the CBG-based transmission.

3. The method of claim 1, further comprising:
configuring, by the base station, a fourth timing indicator for codeblock preemption, the fourth timing indicator indicating a fourth delay between a preemption of at least a portion of a codeblock and a preemption indication (PI); and
transmitting, by the base station, a DCI for PI comprising the fourth timing indicator.

4. The method of claim 3, wherein the scheduling DCI includes information of the DCI for PI.

5. The method of claim 4, wherein the scheduling DCI includes information indicating at least one of:
a fifth delay between the scheduling DCI and the DCI for PI;
a search space for monitoring the DCI for PI; and
at least one PDCCH resource for the DCI for PI.

6. The method of claim 3, wherein the DCI for PI includes information of the scheduling DCI.

7. The method of claim 6, wherein the DCI for PI includes information indicating at least one of:
a sixth delay between the DCI for PI and the scheduling DCI;
a search space for monitoring the scheduling DCI; and
one or more PDCCH resources for the scheduling DCI.

8. A base station comprising:
a non-transitory machine-readable medium storing computer-executable instructions;
a processor configured coupled to the non-transitory computer-readable medium, and configured to execute the computer-executable instructions to:
configure at least one of:
a first timing indicator indicating a first delay between a downlink (DL) grant for a codeblock group (CBG)-based transmission and the CBG-based transmission;
a second timing indicator indicating a second delay between the CBG-based transmission and a hybrid automatic repeat request acknowledgement (HARQ-ACK) for the CBG-based transmission; and
a third timing indicator indicating a third delay between the CBG-based transmission and another DL grant for a pre-Acknowledgement/Non-Acknowledgement (pre-A/N) retransmission of the CBG; and
transmit a scheduling downlink control information (DCI) over a physical downlink control channel (PDCCH), the scheduling DCI comprising at least one of the first, second, and third timing indicators.

9. The base station of claim 8, wherein the processor is further configured to execute the computer-executable instructions to:
transmit the DL grant;
transmit a CBG over a physical downlink shared channel (PDSCH) after the first delay from the DL grant;
transmit the another DL grant after the third delay from the CBG-based transmission; or
receive the HARQ-ACK after the second delay from the CBG-based transmission.

10. The base station of claim 8, wherein the processor is further configured to execute the computer-executable instructions to:
configure a fourth timing indicator for codeblock preemption, the fourth indicator indicating a fourth delay between a preemption of at least a portion of a codeblock and a preemption indication (PI); and
transmit a DCI for PI comprising the fourth timing indicator.

11. The base station of claim 10, wherein the scheduling DCI includes information of the DCI for PI.

12. The base station of claim 11, wherein the scheduling DCI includes information indicating at least one of:
a fifth delay between the scheduling DCI and the DCI for PI;
a search space for monitoring the DCI for PI; and
at least one PDCCH resource for the DCI for PI.

13. The base station of claim 10, wherein the DCI for PI includes information of the scheduling DCI.

14. The base station of claim 13, wherein the DCI for PI includes information indicating at least one of:
a sixth delay between the DCI for PI and the scheduling DCI;
a search space for monitoring the scheduling DCI; and
one or more PDCCH resources for the scheduling DCI.

15. A method comprising:
receiving, by a user equipment (UE), a scheduling downlink control information (DCI) over a physical downlink control channel (PDCCH), the scheduling DCI comprising at least one of:
a first timing indicator indicating a first delay between a downlink (DL) grant for a codeblock group (CBG)-based transmission and the CBG-based transmission;
a second timing indicator indicating a second delay between the CBG-based transmission and a hybrid automatic repeat request acknowledgement (HARQ-ACK) for the CBG-based transmission; and
a third timing indicator indicating a third delay between the CBG-based transmission and another DL grant for a pre-Acknowledgement/Non-Acknowledgement (pre-A/N) retransmission of the CBG;
receiving, by the UE, a CBG over a physical downlink shared channel (PDSCH) after the first delay from the DL grant; and
transmitting, by the UE, the HARQ-ACK after the second delay from the CBG-based transmission.

16. The method of claim 15, further comprising receiving another DL grant after the third delay after the CBG-based transmission.

17. The method of claim 15, further comprising:
receiving, by the UE, a DCI for preemption indication (PI) comprising a fourth timing indicator for codeblock preemption, the fourth indicator indicating a fourth delay between a preemption of at least a portion of a codeblock and a PI.

18. The method of claim 17, wherein the scheduling DCI includes information of the DCI for PI.

19. The method of claim 18, wherein the scheduling DCI includes information indicating at least one of:
a fifth delay between the scheduling DCI and the DCI for PI;
a search space for monitoring the DCI for PI; and
at least one PDCCH resource for the DCI for PI.

20. The method of claim 17, wherein the DCI for PI includes information of the scheduling DCI.

21. The method of claim 20, wherein the DCI for PI includes information indicating at least one of:
a sixth delay between the DCI for PI and the scheduling DCI;
a search space for monitoring the scheduling DCI; and
one or more PDCCH resources for the scheduling DCI.

22. A user equipment (UE) comprising:
a non-transitory machine-readable medium storing computer-executable instructions;
a processor configured coupled to the non-transitory computer-readable medium, and configured to execute the computer-executable instructions to:
receive a scheduling downlink control information (DCI) over a physical downlink control channel (PDCCH), the scheduling DCI comprising at least one of:
a first timing indicator indicating a first delay between a downlink (DL) grant for a codeblock group (CBG)-based transmission and the CBG-based transmission;
a second timing indicator indicating a second delay between the CBG-based transmission and a hybrid automatic repeat request acknowledgement (HARQ-ACK) for the CBG-based transmission; and
a third timing indicator indicating a third delay between the CBG-based transmission and another DL grant for a pre-Acknowledgement/Non-Acknowledgement (pre-A/N) retransmission of the CBG;
receive a CBG over a physical downlink shared channel (PDSCH) after the first delay from the DL grant; and
transmit the HARQ-ACK after the second delay from the CBG-based transmission.

23. The UE of claim 22, wherein the processor is further configured to execute the computer-executable instructions to receive another DL grant after the third delay after the CBG-based transmission.

24. The UE of claim 22, wherein the processor is further configured to execute the computer-executable instructions to:
receive a DCI for preemption indication (PI) comprising a fourth timing indicator for codeblock preemption, the fourth indicator indicating a fourth delay between a preemption of at least a portion of a codeblock and a PI.

25. The UE of claim 24, wherein the scheduling DCI includes information of the DCI for PI.

26. The UE of claim 25, wherein the scheduling DCI includes information indicating at least one of:
a fifth delay between the scheduling DCI and the DCI for PI;
a search space for monitoring the DCI for PI; and
at least one PDCCH resource for the DCI for PI.

27. The UE of claim 24, wherein the DCI for PI includes information of the scheduling DCI.

28. The UE of claim 27, wherein the DCI for PI includes information indicating at least one of:
a sixth delay between the DCI for PI and the scheduling DCI;
a search space for monitoring the scheduling DCI; and
one or more PDCCH resources for the scheduling DCI.
